(19) United States
(12) Patent Application Publication
(10) Pub. No.: US 2005/0182656 A1
(43) Pub. Date: Aug. 18, 2005

(54) On-line prescription service system and method

(76) Inventor: Fred R. Morey, Ann Arbor, MI (US)

Correspondence Address: John G. Posa;Gifford, Krass, Groh, Sprinkle,, Anderson & Citkowski, P.C., 280 N. Old Woodward Ave., Suite 400, Birmingham, MI, 48009-5394, US

(21) Appl. No.: 10/964,555

(22) Filed: Oct. 13, 2004

Related U.S. Application Data
(63) Continuation-in-part of application No. 09/579,637, filed on May 26, 2000, now abandoned.
(60) Provisional application No. 60/136,476, filed on May 28, 1999.

(51) Int. Cl. G06F 17/60

(52) U.S. Cl. 705/2; 382/119

(57) ABSTRACT

The present invention provides a completely automated system and method, whereby the prescription can be created, delivered to the pharmacy, and filled via a computer network. The system and method of the present invention produce accurate prescriptions in a legible format, forward the prescription via electronic means to a pharmacy, and produce printed medication container labels and inserts containing accurate information based on the prescription information received by the pharmacy, thus ensuring quality, reliable, efficient treatment of the patient according to the physician's indications.

### REFERENCE TO PRIOR APPLICATIONS

This application is a continuation-in-part of U.S. patent application Ser. No. 09/579,637, filed May 26, 2000, which claims priority of U.S. Provisional Patent Application Ser. No. 60/136,476, filed May 28, 1999, the entire content of both of which are incorporated herein by reference.

### FIELD OF THE INVENTION

The present invention generally relates to a system and method for pharmaceutical medication prescription preparation and fulfillment. More particularly, the present invention provides a system and method to prepare, forward, and process via a computer network single or multi-medication prescription documents containing clear, concise text in support of individual physician prescription orders.

### BACKGROUND OF THE INVENTION

Current art provides various systems and methods for preparing prescriptions for pharmaceutical products, delivering the prescriptions to a pharmacy, and processing the prescription in an effort to provide the patient with the prescribed pharmaceutical. Traditionally, a physician evaluates a patient's medical condition, selects a medication based on the evaluation, and manually writes an order for the medication in handwritten form, providing the same to the patient. The patient presents the handwritten prescription to a pharmacy, and receives one or more medications based on the handwritten order.

These current methods, however, are highly susceptible to error on the part of the physician, the pharmacy personnel, or both. Variances in the style and clarity of an individual physician's handwriting lead to interpretive errors by those required to read the handwriting, and result in the provision of incorrect medications, medication dosage, and medication formulations to patients. Further, the pharmacy personnel often incorrectly transcribe the information contained on the prescription form, with the aforementioned result. In certain circumstances, information related to medication interaction, contraindications, allergic reactions, and so forth may be incorrectly correlated to the prescription on hand, or the pharmacy personnel may fail to provide the same to the patient. These errors routinely result in serious or fatal consequences for the patient, whereby the pharmaceutical received directly or indirectly causes adverse reactions or death.

In addition to the aforementioned disadvantages, the patient must manually transport the prescription from the office of the physician to the pharmacy to receive the prescribed medication. This process requires a great deal of time, effort, and stamina, and is particularly cumbersome for a patient in need of medical treatment.

Some steps have been taken to alleviate the aforementioned problems by providing various systems and methods designed to provide medication and patient information to a physician prior to issuing a prescription, in hopes of providing a pharmaceutical suitable for treatment of the patient's core condition. Such a system is disclosed in the U.S. Pat. No. 5,845,255 to Mayaud. Similarly, the U.S. Pat. No. 5,833,599 to Schrier, et al. discloses a system and method for processing data related to the use of a medication by a patient that receive patient information to determine a dosage of the medication on the basis of the patient information.

While these steps attempt to provide benefits in the general arena of pharmaceutical provisions to patients, neither addresses the problems arising from errors in writing, interpreting, and transcribing prescription information, and correlating and providing precise, accurate information to the patient receiving the prescriptive medication. What is needed, therefore, is a streamlined, efficient system and method for creating precise, legible prescriptions, accurately processing the prescriptions, and providing the correct medication with accurate instructional and pertinent medical information to the patient.

### SUMMARY OF THE INVENTION

The present invention provides a completely automated system and method, whereby the prescription can be created, delivered to the pharmacy, and filled via a computer network. The system and method of the present invention produce accurate prescriptions in a legible format, forward the prescription via electronic means to a pharmacy, and produce printed medication container labels and inserts containing accurate information based on the prescription information received by the pharmacy, thus ensuring quality, reliable, efficient treatment of the patient according to the physician's indications.

The present invention offers a range of cost-effective embodiments, including embodiments predicated on end-to-end business models utilizing the Internet and private network infrastructures. In one embodiment utilizing the Internet, the physician initially prescribes a medication using a computer device to access a website that hosts a prescription ordering service. From this site, the physician views a web page displaying a formulary, abstract or other information to determine the specific medication and dosage to prescribe. The physician then views a prescription order form, inputs data pertinent to the prescription, and submits the form for delivery to a pharmacy designated by the patient. The website electronically routes the prescription order form to a computer system associated with the pharmacy, typically located on the premises. Alternatively, the website notifies the computer system via email or other means of the pending prescription order, and the pharmacy personnel utilize the computer system to access the website and view the prescription.

Once the pharmacy views the prescription order form, the pharmacy personnel fill the prescription order and utilize a variety of software menus to print the container label and package inserts. The pharmacy personnel may also utilize various tools such as a local or remote (website) database to retrieve information pertinent to the patient, the medication, or insurance coverage.

In another embodiment utilizing a private network, the physician generates a prescription via various means. For example, the physician utilizes a form containing a combination of preprinted information and information handwritten by the physician as a prescription order. The physician provides the document to the patient for manual transmission to the pharmacy. The pharmacy utilizes a computer system having prescription service software to verify and fill the prescription order.

Alternatively, the physician utilizes a computer device having voice-recognition software to dictate the prescription order. The computer device transmits, via wireless or other means, the voice data received therein, across a private computer network to a destination computer system having a prescription service application. The destination computer system converts the voice data to text data, authenticates the data, and stores the data for retrieval by a designated pharmacy.

The foregoing examples represent several of the embodiments of the present invention; however, one skilled in the art will recognize that the invention described herein may be implemented in a variety of ways.

### BRIEF DESCRIPTION OF THE DRAWINGS

FIG. 1 is a flow diagram of the transaction data of an embodiment of the method according to the present invention;

FIG. 2 illustrates a sample formulary pick-list paper document of an embodiment according to the present invention;

FIG. 3 illustrates a screen displaying information related to a sample online formulary pick-list form according to the present invention;

FIG. 4 illustrates a screen displaying a sample prescription order form according to the present invention;

FIG. 5 illustrates a screen displaying a virtual prescription order form according to the present invention;

FIG. 6 is a drawing of a drug order process flow according to the invention in a physician environment;

FIG. 7 shows a drug order process flow according to the invention with respect to a retail pharmacy environment;

FIG. 8 shows a physician/prescriber professional information online registry data input;

FIG. 9 shows a physician/prescriber preferred drug registration form online generator;

FIG. 10 shows a physician/prescriber preferred drug registration form text data inventory;

FIG. 11 shows a physician's preferred drug handwriting inventory form prescription data images;

FIG. 12 shows how an e-mail address is issued upon approval;

FIG. 13A illustrates a physician prescription pad system registration procedure;

FIG. 13B is a drawing that illustrates how archived gold signature is reference matched to a prescription signature;

FIG. 13C illustrates the way in which this particular physician's handwriting and shorthand are used;

FIG. 13D is a drawing which shows prescription pad drug order image conversion;

FIG. 14A is a drawing which shows the way in which healthcare card identification numbers are entered into a data field once the prescription has been uploaded to the server;

FIG. 14B is a drawing which shows additional information about the patient;

FIG. 15 shows a typical physician environment according to the invention, involving a prescription order encrypted file transfer output;

FIG. 16 illustrates an embodiment of the invention wherein a point of sale screen is used to view patient and prescription information; and

FIG. 17 illustrates an overall drug order conversion and process flow.

### DETAILED DESCRIPTION OF THE INVENTION

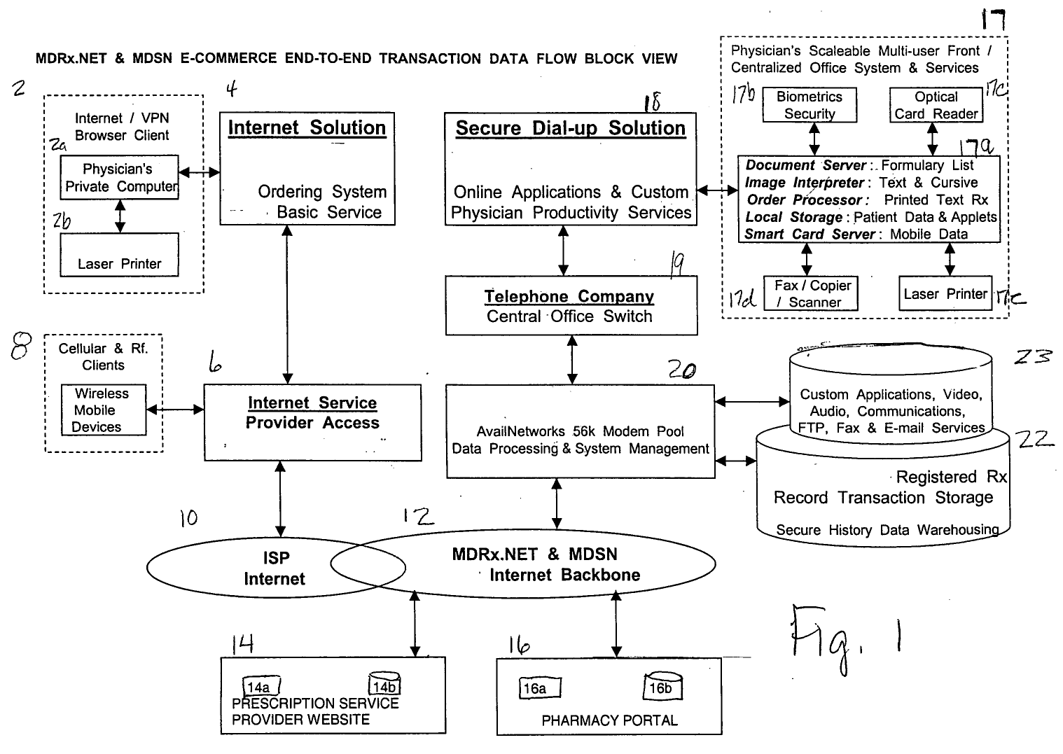

Referring now to the drawings wherein like numbers are used to denote like items throughout, FIG. 1 shows in conceptual diagrammatic form an illustration of the a method according to the present invention for providing global online prescription services. The global online prescription service method provides integrated public network and private network infrastructure for efficient, accurate legible prescription generation, labeling, and information provision.

Initially, the physician selects an access method to the service network, typically via an Internet solution 2, depicted in phantom lines. The physician uses a computer device such as a private computer 2a having browser software and an associated laser printer 2b to interface with the ordering system basic service 4. The private computer 2a establishes a communications link with and Internet service provider 6 providing a portal into the Internet 10. Alternatively, the physician utilizes a wireless mobile device 8 such as a cellular phone or a personal digital assistant. The mobile device 8, depicted in phantom lines, employs any one or a combination of communication technologies to link to the service provider 6.

Once the physician establishes the communications link, the physician visits the prescription service provider's website 14 having a server 14a, a website database 14b, and an interactive suite of application software, including the ordering system basic service software 4, designed to support online prescription services. The physician views a number of web pages displaying various information, as hereinafter described, inputs transaction data relative to the prescribed medication, the patient information, the pharmacy information, and the physician information. The physician can print the web pages containing the input transaction data on the associated printer 2b for archival or other purposes. The physician completes the transaction by submitting an instruction to the prescription service provider's website to electronically forward the transaction data to the designated pharmacy.

The server 14b stores the transaction data in the website database 14b and dynamically routes a notification message via the Internet backbone 12 and utilizing various communication software formats; e.g., email, to the pharmacy portal 16 having a pharmacy computer system 16a with associated pharmacy software, a pharmacy database 16b, and a printer 16c.

On receipt of the notification message by the pharmacy computer system 16a, or at predetermined intervals, the pharmacy personnel utilize the computer system 16a to establish a communications link via the Internet backbone 12 to the prescription service provider website 14 to access the completed prescription order.

Once the pharmacy personnel access the transaction data of the completed prescription order, the pharmacy previews the prescription order containing the transaction data on the pharmacy computer system 16a to enable the fulfillment of the prescription order. Alternatively, the pharmacy personnel utilize pharmacy computer system 16a to retrieve the transaction data via the aforementioned communications link, and to store the transaction data in the pharmacy database 16b of the pharmacy portal 16. The database 16b may be organized to facilitate patient profiles, accounting and reporting functions, or other combinations of predetermined business objectives. For example, the pharmacy database 16b store data representing every prescription order filled for a particular patient. Upon receipt of a new prescription order to be filled, the pharmacy computer system 16a and its associated pharmacy software performs a mandatory search of every medication provided to the particular patient within a predetermined time interval, cross-correlates each medication found to the medication ordered to determine any negative reactions anticipated from such a correlation, and warns the patient of the same via a message printed on the label and package insert.

The pharmacy personnel utilize both the website database 14b and the pharmacy database 16b to retrieve information correlating to the prescribed medication for distribution to the patient; e.g., contraindications, medical alerts, and so forth. As a final step, the pharmacy computer system 16 electronically transfers the medication information to the printer via a direct physical link or other means, and the printer prints the label and package insert information.

As an alternative to utilizing an Internet solution to access the online prescription services, the physician initially accesses a centralized office system 17 to create a digital prescription order. The present invention anticipates multiple configurations of hardware devices and software, whereby the centralized office produces the digital prescription order. Various configurations of the centralized office system 17 include computer devices 17a such as a document server having a formulary list; an image interpreter for converting the text and cursive found on a paper document into electronic data; an order processor for producing printed text prescriptions; a local storage device for storing patient data and software applets; and a smart card server for capturing mobile data. The computer devices 17a utilize a variety of peripheral devices; e.g., a biometrics security device 17b, an optical card reader 17c, a facsimile/copier/scanner device 17d, or laser printer 17e, in the digital prescription order creation process.

In one example, the document server produces a paper formulary list, hereinafter described, from which the physician selects a medication for the patient. The physician scans the completed formulary document into the centralized office system 17 utilizing a scanner 17d, whereby the next step of the prescription order service method begins.

In the next step, a computer device of the centralized office system 17 establishes an electronic link via a private network; typically utilizing a secure, dialup connection 18 and online applications that promote physician productivity.

Once the centralized office system 17 connects to a private switched network 19, and the digital prescription order traverse the private switched network 19 to a prescription service provider's computer host 20 having web site functionality. The prescription service provider's computer host 20 is configured to provide the same functionality as the afore-described prescription service provider website 14, both of which offer secure data warehousing services, such as transaction record storage 22, typically for registered participants of the online prescription services. The prescription service provider's computer host 20 is generally configured to supply members with custom applications, video, audio, communications, FTP, fax, and email services, as well.

Upon receipt of the digital prescription order from the centralized office system 17, the prescription service provider's computer host 20 send an electronic notification message via an Internet link to the pharmacy portal 16, which proceeds to retrieve and process, and fill the digital prescription order in the same manner as the prescription orders received by the prescription service provider website 14.

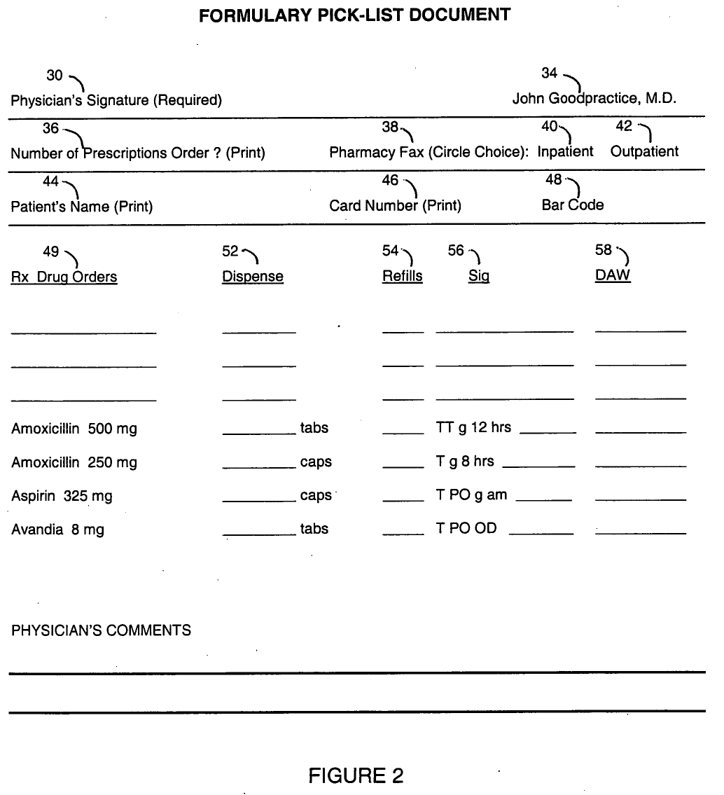

With respect to FIG. 2, the drawing illustrates a sample formulary pick-list document utilized by the physician as a source document for generating a prescription order. The sample formulary pick-list contains the following preprinted areas labeled as or representing the Physician's Signature (Required) 30, the name of the physician 34, the Number of Prescriptions Ordered 36, the Pharmacy Fax 38, for inpatient 40 or outpatient 42 prescription orders, the Patient's Name 44, the Patient's Card Number 46, the Bar Code 48, a list of medications 50, and correlating lists indicating the form of dispensation 52, the number of refills 54, the system originated symbols 56, and the physician handwritten initials 58, for completion by the physician.

After the physician provides the necessary information to prescribe a medication; e.g., the physician's signature, the number of prescriptions ordered, the patient's name, etc., and selects the medication or medications to be prescribed, the completed sample formulary pick-list document is scanned into the centralized office system 17 shown in FIG. 1 and converted into a digital prescription order form. The software associated the centralized office system 17 shown in FIG. 1 verify portions of the information contained on the sample formulary pick-list document.

For example, and again referencing FIG. 2, signature pattern recognition software analyzes and validates the physician's signature, or detects a forged signature and requires a security override by an authorized staff member before processing of the prescription order can continue. Other software performs validation, processing, and error-checking functions such as comparing the number entered in the number of prescriptions ordered 36 field with the total number of selections entered; and detecting the pharmacy fax number 38 and forwarding the digital prescription order form via electronic means to the facsimile machine of the designated pharmacy. Further, the software recognizes, confirms and retrieves patient information from an encrypted database associated with the aforementioned centralized office system 17 of FIG. 1, and produces a history review to prevent drug adverse reactions and interactions.

Other software processing options include decoding the bar code 48 that represents the patient's identification and cross-referencing the bar code 48 with information from the encrypted database to verify patient's and physician's identities, confirm pattern recognition prints complete patient data on individual pharmacy orders, route digital prescription orders based on the bar code 48, and reject digital prescription orders that do not meet predetermined verification criteria.

The software matches the medication selected from the list of medications 50 and the physician with a National Drug Code (NRC) designation and form of dispensation 52 entry and stores these in conjunction with an individual digital prescription order reference number. If the software detects a “no match” condition between the selected medication and the NDC, then the system copies the physician's handwritten prescription from the multi-drug prescription formulary for print as a single prescription order. The information entered by the physician in the form of dispensation area 52 dictates the quantity of medication provided to the patient. If the physician fails to complete an entry in the form of dispensation area 52, then the system defaults to a predetermined standard prescribed quantity.

The software checks the refill 54 area to determine the number of times the original prescription order can be replenished. If the refill 54 area lacks any entry, then the prescription order is filled and labeled with no refills available. The system-originated symbols 56 represent dosage, usage or other instructive comments for the patient. If symbols are not indicated by the physician on the formulary pick-list document, then the system defaults to the displayed abbreviations. The physician handwritten initials area 58, if initialed, prohibits generic drug substitutions by the pharmacy by instructing the pharmacy to dispense a medication as written. The software performs verification check on initials entered into the physician handwritten initials area 58, and permits processing of the digital prescription order to proceed if the initials are validated. If the physician's handwritten initials area 58 lacks initials, then the digital prescription order forwarded with a “generic acceptable” designation to the pharmacy.

As an alternative to utilization of a private network for delivery of the digital prescription order to the pharmacy, the physician's staff may print the digital prescription order on printer 17c depicted in FIG. 1 and present the printed prescription order to the patient for presentation to the pharmacy.

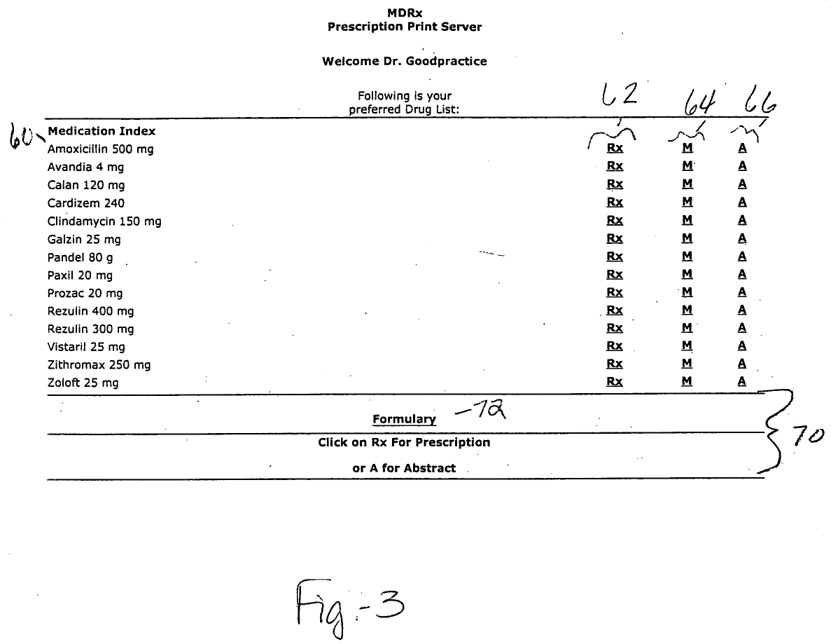

In various embodiments, alternatives to the sample formulary pick-list document described in FIG. 2 are available. For those physicians who choose to utilize the Internet for prescription generation, online documents and information can be accessed at the prescription service provider website 14 shown in FIG. 1. Once the physician accesses the prescription service provider website, the physician views a series of web pages displaying screens of information. For example, as depicted in FIG. 3, a web page displays information tailored to the physician's formulary, including a medical index 60, with correlative hyperlinks for each item in an order column 62, a prescription generator 64, and an abstract column 66. With regard to abstract column 66, if the a link is selected, then a web page displays detailed information about the medication therewith. Informational area 70 displays various instructional and informational text, including a hyperlink to a complete formulary 72.

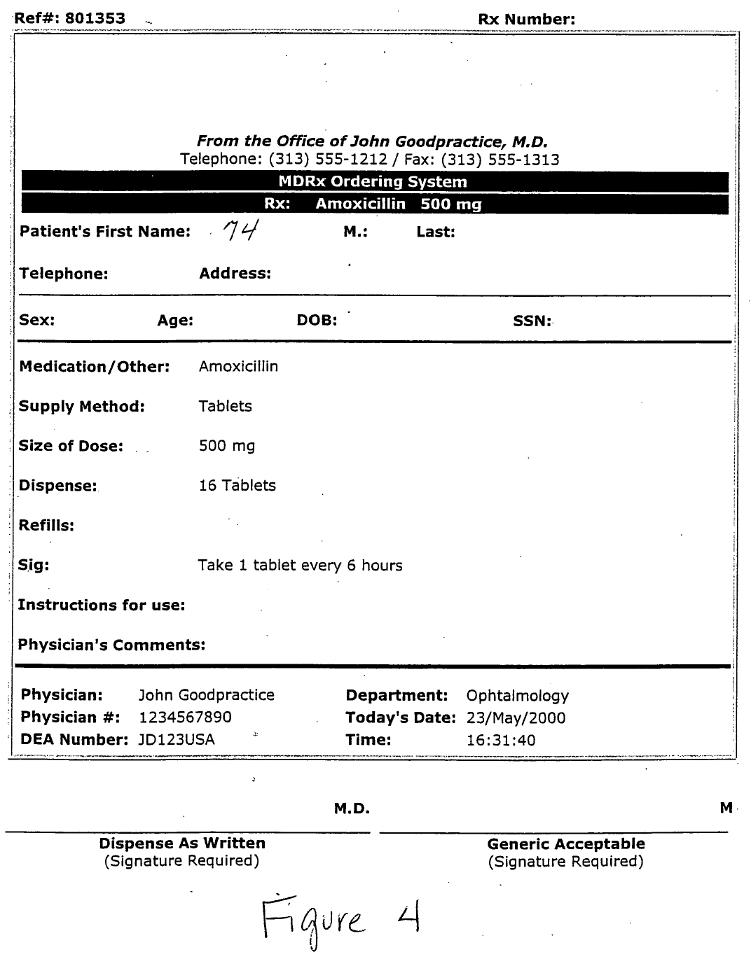

If the physician selects a hyperlink from the order column 62, server software invokes a second web page depicted in FIG. 4 that display an online prescription order form. The physician inputs required information into various texts fields, such as the patient's name 74, and prints the screen to produce a paper prescription order for the patient.

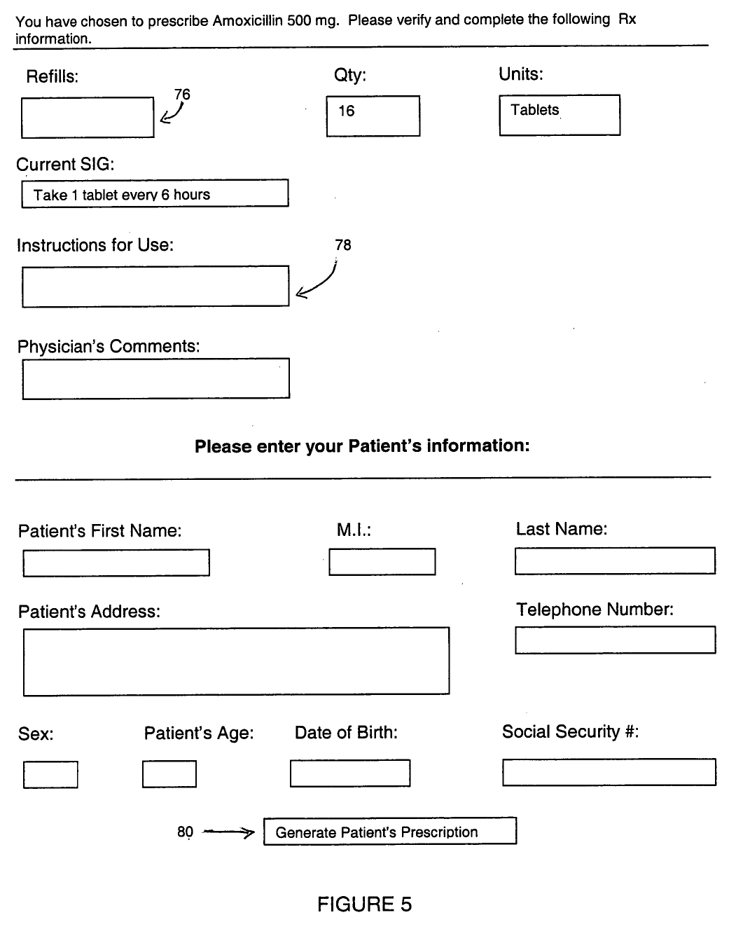

Alternatively, the physician selects a link from the prescription generator 64 to invoke a web page such as the one illustrated in FIG. 5. The web page displays a virtual prescription form wherein the physician enters data into the text fields provided; e.g., the number of refills 76, the instructions for use 78, and so forth. When complete, the physician submits the form to the server by clicking on the button 80. The prescription service provider website electronically processes the virtual prescription form according to a predetermined process; e.g., notifying a pharmacy portal for online retrieval of the same.

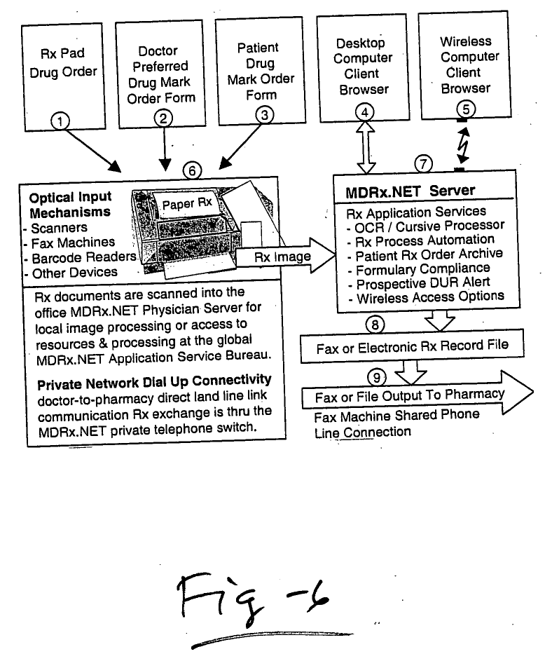

FIG. 6 is a drawing of a drug order process flow according to the invention in a physician environment. As can be seen from the figure, prescription input may take multiple forms, including a prescription pad drug order, doctor-preferred drug mark order form or patient drug mark order form. These inputs may be entered into various optical input mechanisms, including scanners, fax machines, barcode readers and other devices to generate a prescription image to be stored on a server. A desktop computer client browser or wireless computer client browser may alternative be used to access the server, to generate a fax or electronic prescription record file which is output to a pharmacy or other drug-dispensing entity.

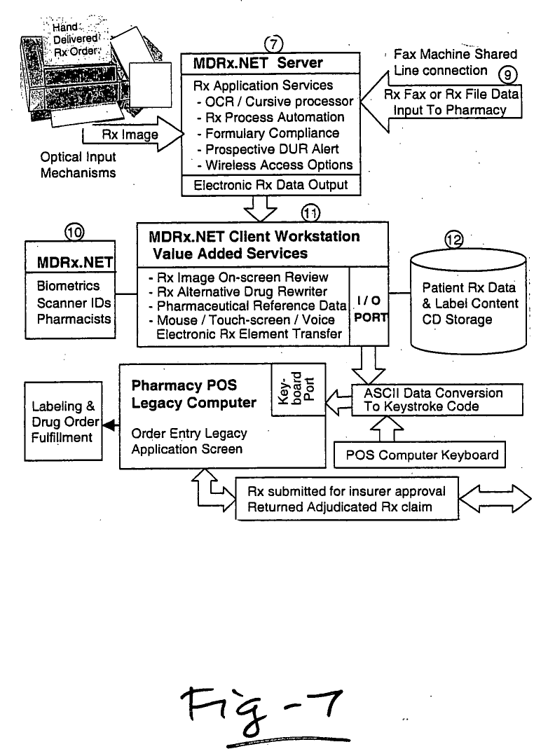

FIG. 7 shows a drug order process flow according to the invention with respect to a retail pharmacy environment. As shown in the figure, information stored on a server is accessible to various client workstations providing value-added services. Note the use of an I/O port that performs an ASCII data conversion keystroke code through a keyboard entry system, thereby dramatically streamlining the data-gathering process.

Various application services provide ambulatory prescription safety and productivity resources. Details regarding FIGS. 6 and 7 include the following:

Peer-to-Peer Source Rx Exchange

Physician-to-pharmacy direct dial-up land line communication private switch telephone network. Rx process center/Rx file and fax arbitrated output.

Client/Server Internet Access Resources

Doctors handwriting inventory reference data—insurance info—ADE analysis—FDA information—manufacturing drug text and audio/video presentations—site archives no identifiable patient information.
1) Rx Pad Drug Order Handwriting. Conversion requires no change in the doctor's routine to output electronic Rx record data.
2) Preferred Mark Order Form. Preprinted drug pick-list for doctors with a compilation of less than 30 favorite drugs.
3) Patient Mark Order Form. Up-to-date patient drug information and Rx history with Rx refill and renewal check boxes.
4) Desktop Computer and Browser. Point/click user interface picks drug, signature and patient information to build electronic Rx record data.
5) Mobile Wireless Computer Devices. Connect point-of-care doctors to online insurer plan information and drug prescribing resource services.
6) Optical Scan Mechanism Rx Server Input. Automatic signature index launch and cursive recognition match retrieves doctor Rx data.
7) MDRx.NET Application Server. Physician system converts scanned Rx pad cursive data images into electronic Rx records. Pharmacy system converts scanned images of and-delivered Rx pad orders into digital format. Rx electronic data aids Rx safety DUR analysis.
8) Electronic Prescription Record (EPR) Data. Let computers perform process automation, Rx safety quality control and transfer to EMR.
9) Shared Single Facsimile Line Rx Data Transfer. Arbitration is conducted by MDRx.NET server.
10) Biometrics Scanner Authentication. Rx processing order entry sessions start and end with biometrics identity verification of system user pharmacist.
11) MDRx.NET Pharmacist Workstation ASCII. Text parsed data are translated to keystrokes. Automated text input limits transcription typing. Doctor direct Rx order entry improves accuracy, Rx safety, Rx throughput and saves process time.
12) CD Electronic Rx Data Warehouse Storage. Captures original Rx orders and label data.
13) Insurance Pharmacy Benefit Manager (PBM) Prescription Formulary Compliance And Assessment For Reimbursement.

An important aspect of the invention involves a preferred drug and handwriting registration process. A drug handwriting inventory template aids in more precise recognition and transcription prescription pad drug ordering information. The aim is to generate digital drug text from the prescriber's handwritten prescription-pad order. Conversion of cursive paper prescription data to computer readable text facilitate; accurate drug order communication, prescription drug formulary compliance, prescription quality control and process automation of doctor/pharmacy prescription procedures.

Preferred drug handwriting inventory images provide physician prescription-pad data transcribed content for reference by the doctor's staff, pharmacy staff and other health care professions. Captured original signature and initials serve as a quick on-line authentic reference standard to impede prescription forgery and deception.

Electronic Prescription Record (EPR) data reduces time-consuming phone calls made by the pharmacy to the prescriber to clarify illegible drug orders. Correct prescription data recognition decreases malpractice potential for health care professionals and patient risk of adverse drug events.

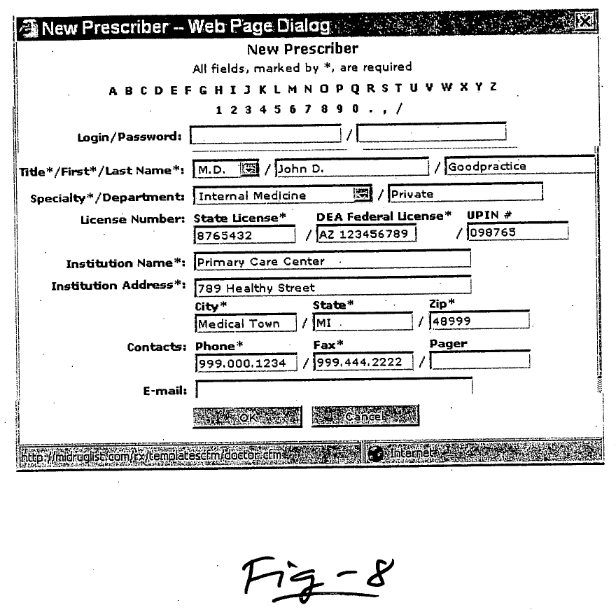

FIG. 8 shows a physician/prescriber professional information online registry data input. Authorized personnel may supply physician information for database archive. Title and practice specialty are menu-selected data items. Prescriber entered text data such as name, license, doctor's institution ID number, business/institution name, address and contact data are captured as reference sources for verification of the prescriber's prescription pad order information.

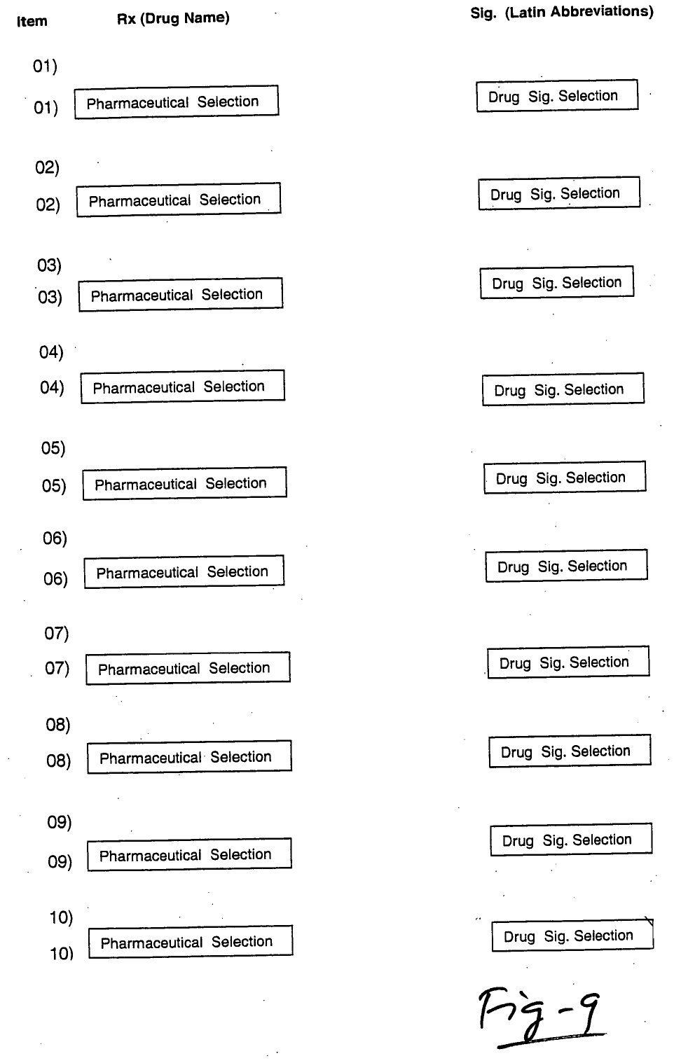

FIG. 9 shows a physician/prescriber preferred drug registration form online generator. Pharmaceutical inventory template contains document barcode ID and frequently prescribed drug and signature fields ready for data selection. Form documentation is archived for retrieval by the prescriber's information, such as name, state license number or DEA number.

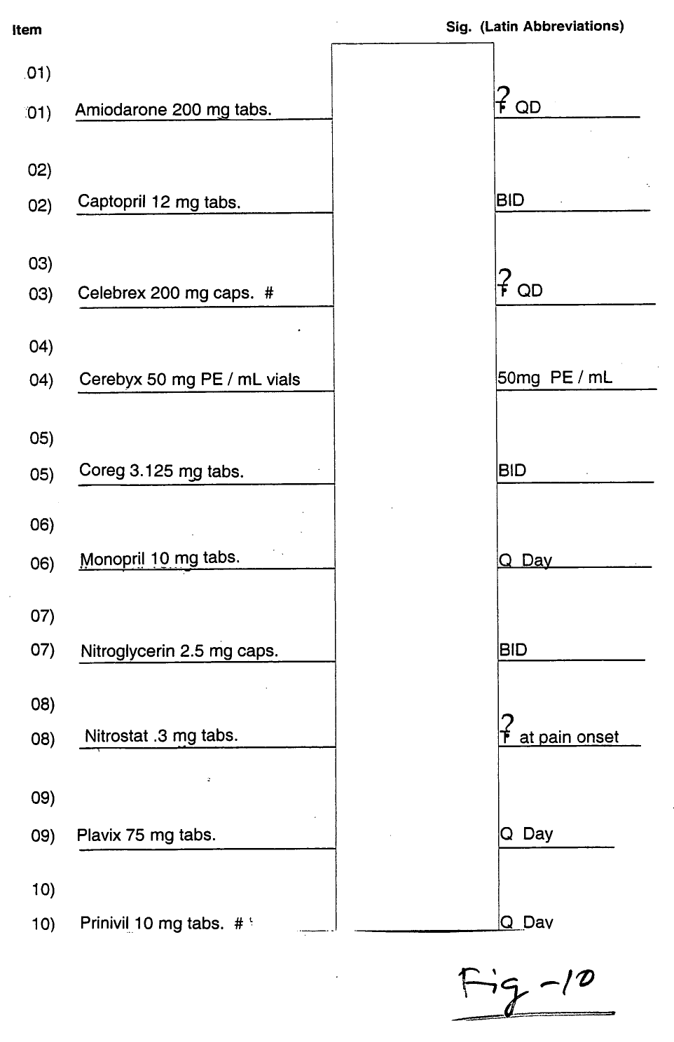

FIG. 10 shows a physician/prescriber preferred drug registration form text data inventory. Pharmaceuticals identified to have insurer formulary prior authorization requirements are highlighted. Documentation form selected computer text is ready for review, modification and printout.

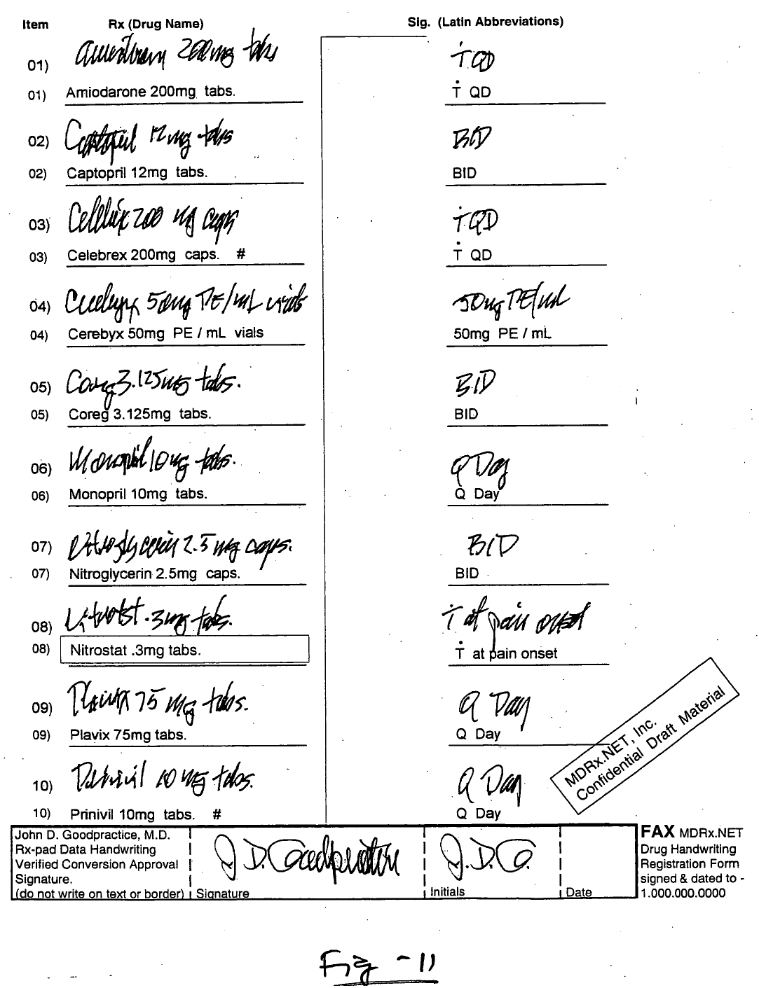

FIG. 11 shows a physician's preferred drug handwriting inventory form prescription data images. Registered physician/prescriber only completes FIG. 11 form required information. Item number drug and signature text are to be covered in the prescriber's handwriting. Cursive prescription models are certified as accurate by the prescriber's conversion signature approval.

Document signature and initials are archived for online retrieval and comparison as the prescriber's authentic reference sources. Completed form(s) may be faxed or e-mailed as attached documents or sent as a secure encoded portable document type of file to the designated registration center. Received documentation is automatically routed for review, accuracy and best-medical-practice.

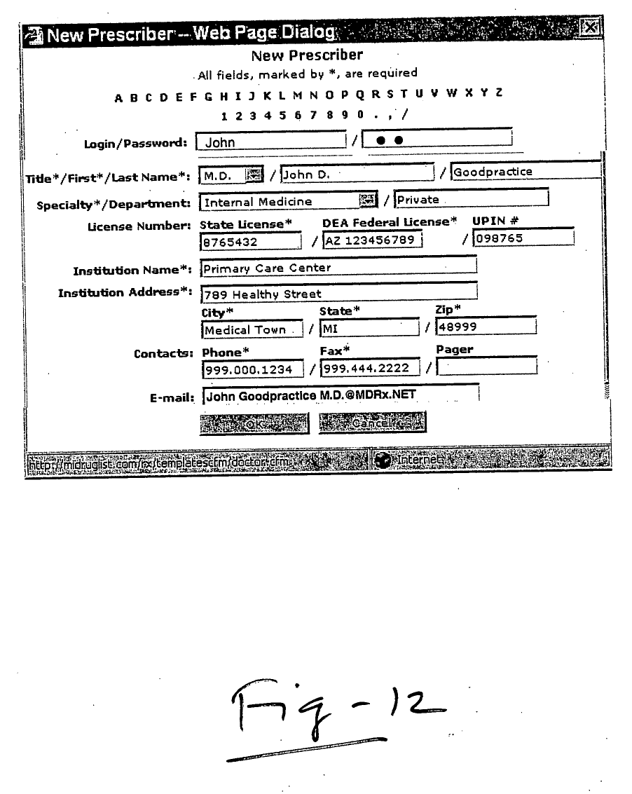

Process center approved acceptance results in registered prescriber clients being issued a services password and an e-mail address. Physicians and pharmacies exchange prescription data end-to-end by facsimile or text file private communication. FIG. 12 shows how an e-mail address is issued upon approval.

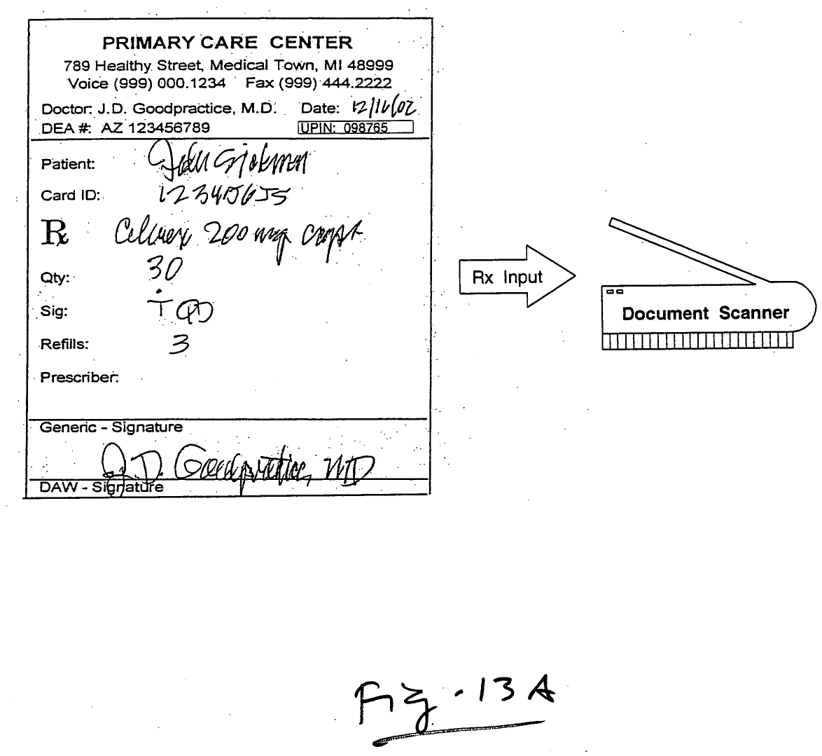

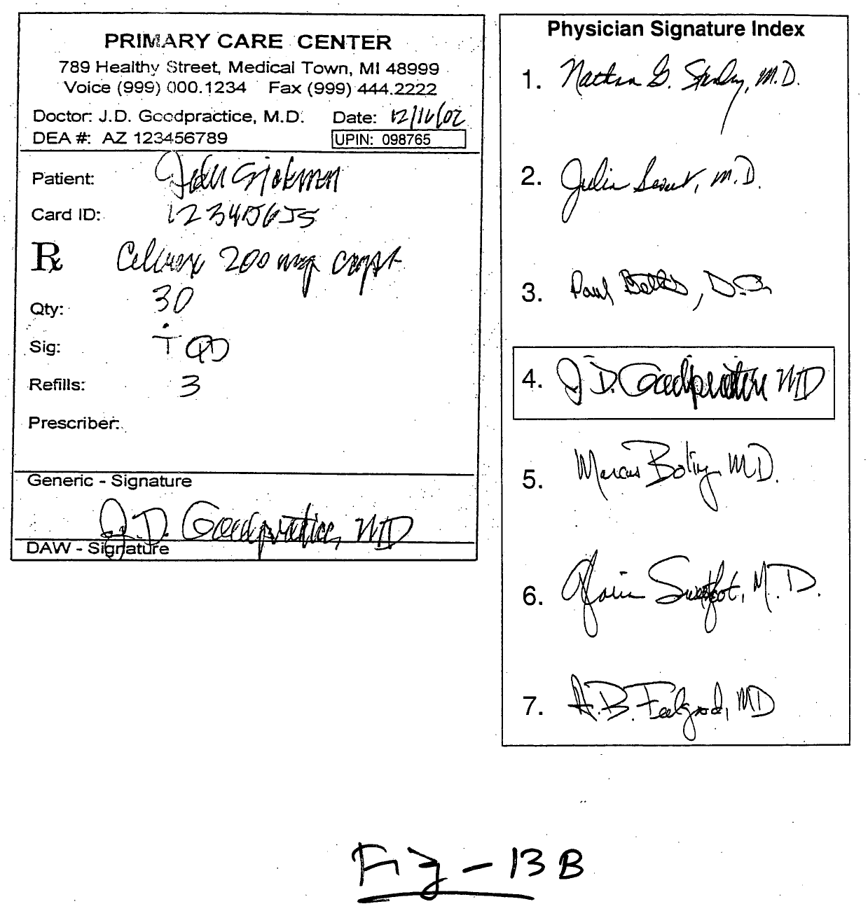

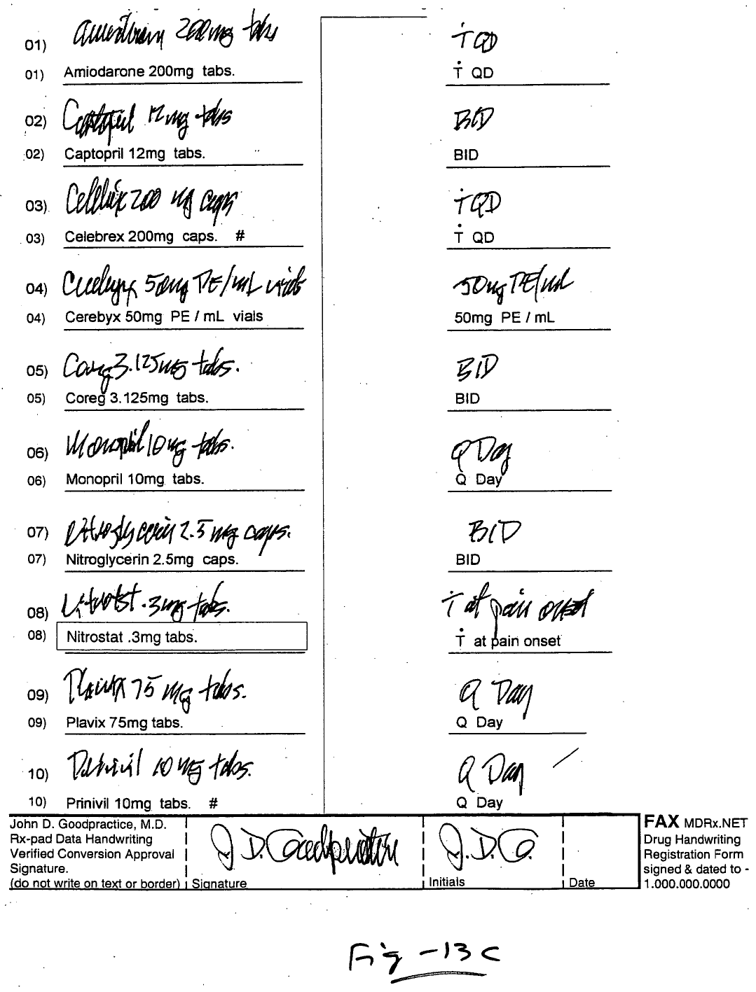

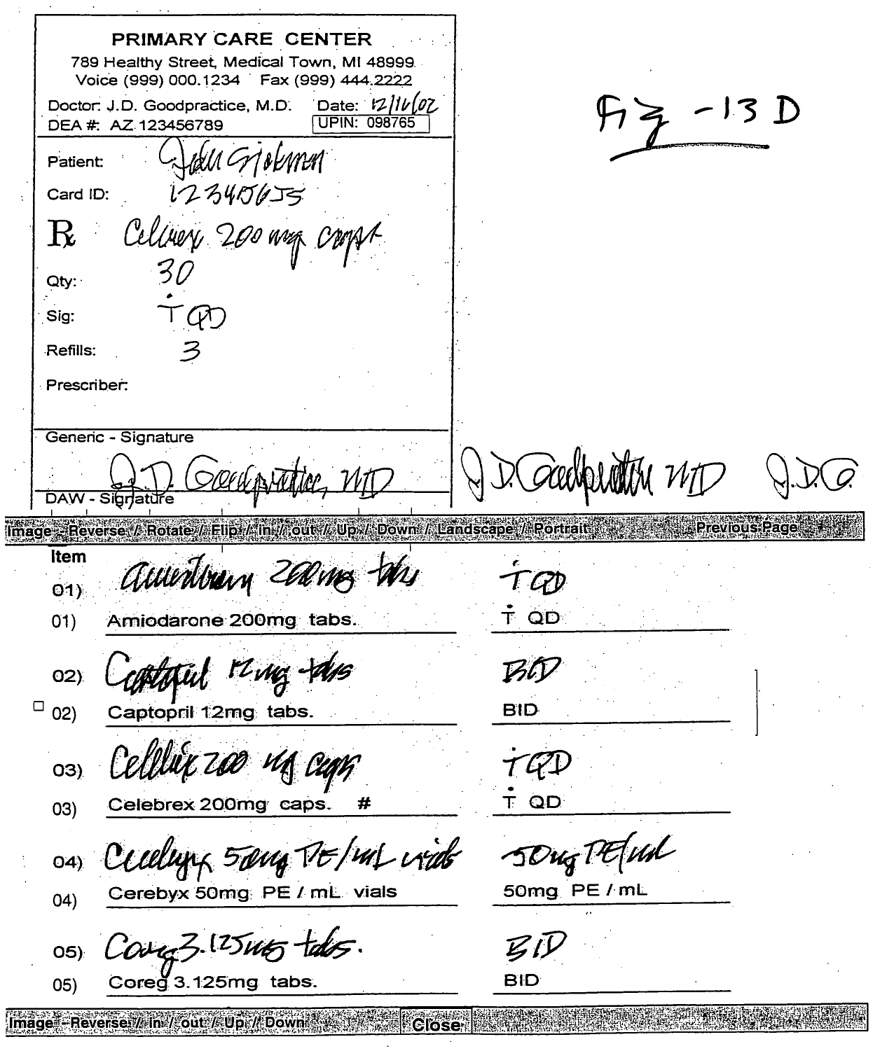

A scanned prescription pad input process according to the invention is depicted in FIGS. 13A-13D. FIG. 13A illustrates a physician prescription pad system registration procedure. Among the steps associated with this process, a prescription form is deskewed for an appropriate screen orientation and the pad form target reference points are coordinated with profile training. Characters and image handwriting zones are imaged through optical recognition, and data patterns are identified so that extraction can take place. In particular, the optical recognition is used to retrieve the doctor's signature index as well as potentially other information.

FIG. 13B is a drawing that illustrates how an archived signature is reference matched to a prescription signature. The prescription and index signature match automatically launches a doctor's preferred drug handwriting recognition system. A displayed handwriting model is used to match with an in-hand prescription data visual means or automated optical recognition. A patient prescription drug is matched to the handwriting model drug item to generate a basic text drug order, which automatically launches the doctor's preferred drug handwriting system. As shown in the figure, the generic signature shown on the written prescription pad is automatically indexed to stored position signatures, finding that No. 4 is an appropriate match.

FIG. 13C illustrates the way in which this particular physician's handwriting and shorthand are used, and previously stored to make comparisons with the drug prescribed on the form. FIG. 13D is a drawing which shows prescription pad drug order image conversion, thereby identifying the correct prescription and other information such as how the drug is consumed, number of refills, and so forth. Note that this and in other embodiments, a split-screen displays both the doctor preferred handwriting recognition system and the prescription image. This allows an item number image recognition comparison to match to the scanned prescription order, which may be performed manually by a staff member. The identified pharmaceutical prescribing history may be displayed in descending strength. Thus, according to the invention, an automated optical handwriting character recognition method provides a range of options for staff, final review and determination.

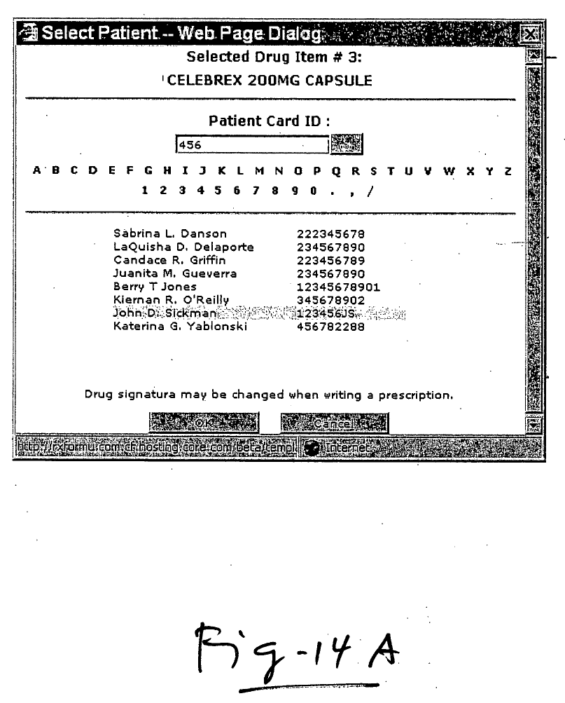

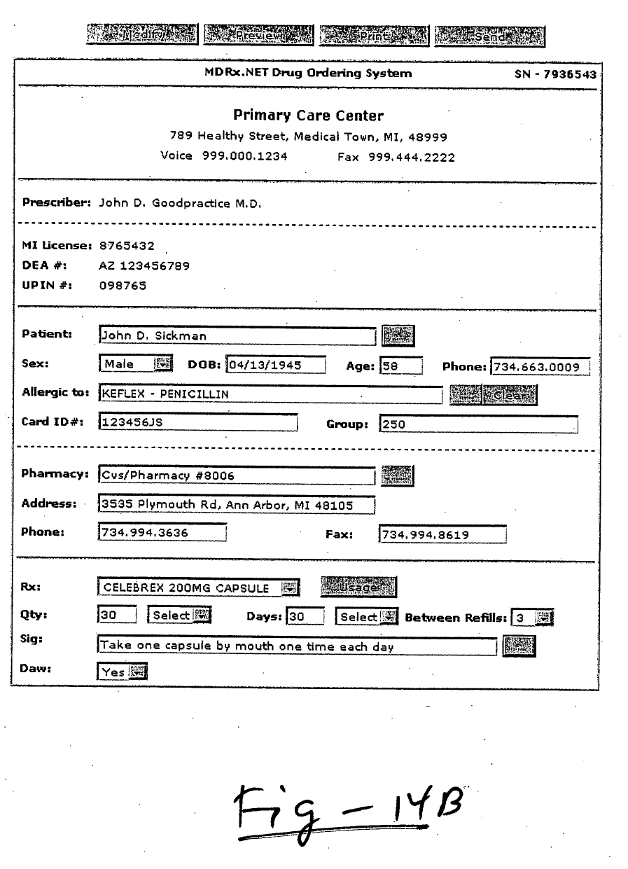

FIG. 14A is a drawing which shows the way in which healthcare card identification numbers are entered into a data field once the prescription has been uploaded to the server, and in this case, entry of code 456 highlights “John D. Sickman,” in one of the fields below. This, in turn, populates fields with additional information about the patient, as shown in FIG. 14B. A drug order is now ready for review, with data modification being possible. A “send” command outputs data as a combined prescription image and text data file, or as a combined fax document.

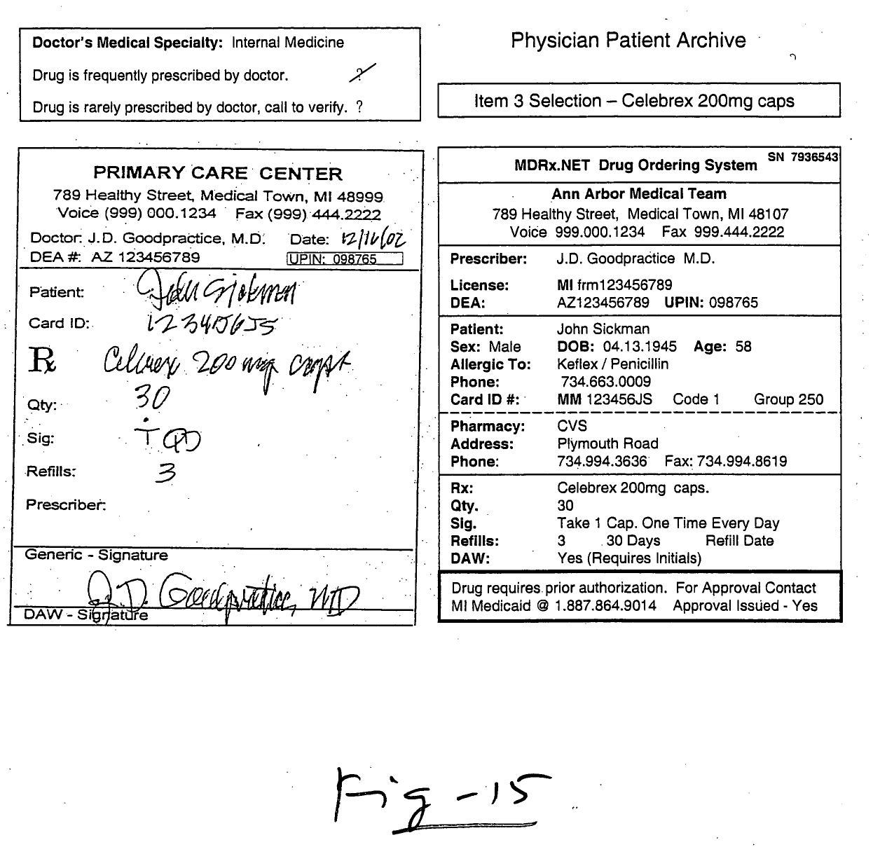

FIG. 15 shows a typical physician environment according to the invention, involving a prescription order encrypted file transfer output. This allows patient-of-care insurer of pre-qualified prescription information, as well as a secure correct dial-up to the telecommunication switch and server. The conversion of file information to fax compatibility is dependent upon the receiving pharmacy system. Nevertheless, an advantage of the system, as can be seen from FIG. 15, is the use of multiple windows wherein, in one window, there is an image of the handwritten order that was scanned, and in other window, there is a list of drugs that the doctor has generally prescribed in his own handwriting, having made the comparison, one is provided with a printed version of those drugs as well as the ability to access additional information regarding those drugs, including dosage limits, whether it is a controlled substance, and so forth.

The handwritten form may then be merged with a textual, more easily readable form into a single unit that gets sent to the pharmacy, so that there is no ambiguity about what should be prescribed, how prescribed it, and who the patient is. As an option, various machine-readable codes may be sent along with such transmissions, including barcodes, and the like, indicating such information as who the patient is, what the drugs are, as well as which authority or certification type is being used. Although there may be different types of barcodes used by different pharmacies or drug-dispensing entities, individuals simply tell the system what kind of code they are using, and the invention automatically remembers which code to generate when transmissions are made. As such, when the pharmacy or other dispensing institution receives a remote fax or printout, they can use their standard equipment to read the code.

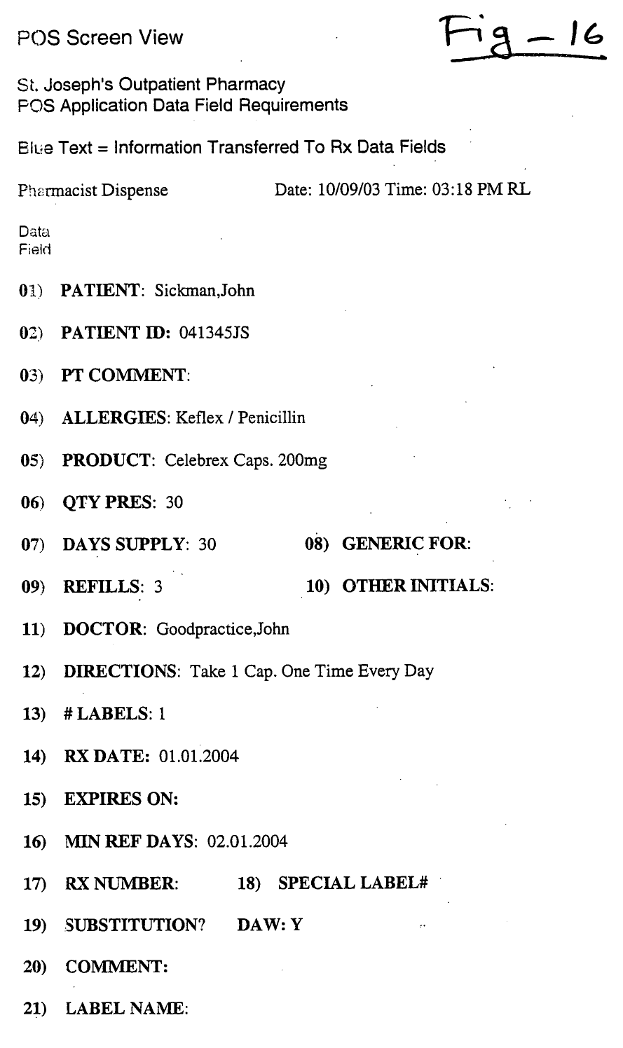

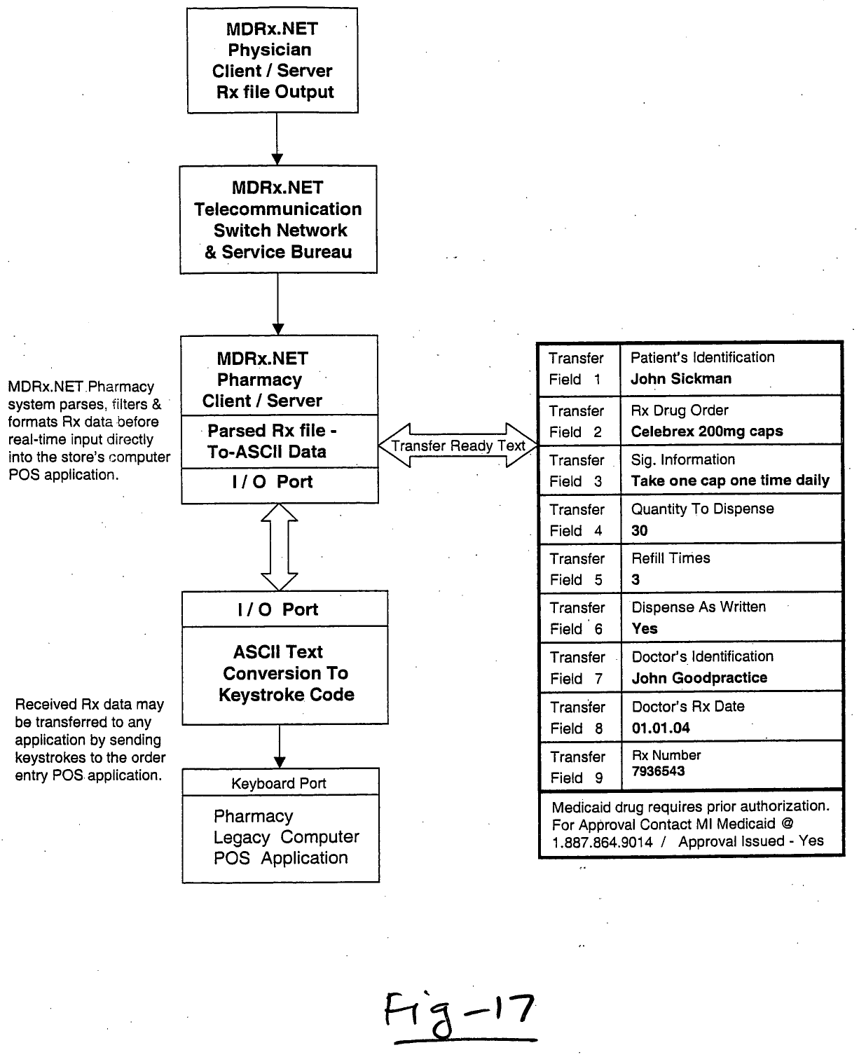

FIG. 16 better illustrates an embodiment of the invention wherein a point-of-sale screen is used to view patient and prescription information, including the possibility of allergic reactions, number of refills, who the doctor is, and so forth. FIG. 17 illustrates an overall drug order conversion and process flow. A physician workstation client/server system transmits drug order faxes, file data and combination fax image with a transcribed digital prescription text file to the patient's retail pharmacy. A private telecommunications network provides a physician-to-pharmacy point-to-point direct prescription exchange.

A direct dial-up to a private telecommunication switch and bureau services maintains secure prescription data deliver to the pharmacy. Registered computers and fax machines are eligible to transmit drug order file data and faxes to any pharmacy. prescription transmitting devices profiles are captured as reference data to verify sender and to ensure process and system integrity. An exchange delivers drug orders to the pharmacy and returns to the sender a date stamp confirmation notice.

Having illustrated and described the principles of the invention in a preferred embodiment, it should be apparent to those skilled in the art that the embodiment can be modified in arrangement and detail without departing from such principles. For example, the appearance of the various screen displays and the arrangement of options by the system may be changed if preferred.

Therefore, the illustrated embodiment should be considered only as the preferred example of the invention and not as a limitation on its scope, which is defined by the following claims. We therefore claim as our invention all modifications and equivalents to the embodiment coming within the scope and spirit of these claims.

1. A method of filling a prescription, comprising the steps of:
inputting and storing a physician's handwriting sample;
manually filling out a prescription order form for a patient involving a medication;
scanning and digitizing the prescription order form to create printed regions and handwritten regions;
comparing one or more of the handwritten regions to the physician's handwriting sample; and
if there is a match between one of the handwritten regions and the physician's handwriting sample, proceeding with other steps associated with filling the prescription.

2. The method of claim 1, wherein the physician's handwriting sample is the physician's signature.

3. The method of claim 1, wherein the physician's handwriting sample is the physician's initials.

4. The method of claim 1, wherein the physician's handwriting sample includes the names of medications commonly prescribed by the physician.

5. The method of claim 1, wherein the other steps associated with filling the prescription include the step of accessing formularies or abstracts relating to the medication.

6. The method of claim 1, wherein the other steps associated with filling the prescription include the step of accessing information regarding recommended dosages for the medication.

7. The method of claim 1, wherein the other steps associated with filling the prescription include the step of accessing information regarding side effects associated with the medication.

8. The method of claim 1, wherein the other steps associated with filling the prescription include the step of accessing information about the patient.

9. The method of claim 1, wherein the other steps associated with filling the prescription include the step of accessing information about insurance coverage.

10. The method of claim 1, wherein the other steps associated with filling the prescription include:
transmitting the prescription order to a pharmacy; and
filling the prescription at the pharmacy.

11. The method of claim 1, further including the step of accessing a database enabling the pharmacy to print a container label or package insert for the prescription.

12. The method of claim 1, wherein one or more of the steps are carried out over a computer network.

13. The method of claim 12, wherein the network is the Internet.

14. The method of claim 12, wherein the network is a private network, and the method further includes the steps of:
providing the authorized user with a form containing a combination of preprinted information and fields to be completed;
completing the fields by the authorized user; and
delivering the form to a pharmacy.
